(19) United States
(12) Patent Application Publication
(10) Pub. No.: US 2010/0229742 A1
(43) Pub. Date: Sep. 16, 2010

(54) Damping Water Circulator

(76) Inventor: Atsushi Shinnishi, Tokyo (JP)

Correspondence Address: The Law Office of Michael E. Kondoudis, 888 16th Street, NW, Suite 800, Washington, DC, 20006, US

(21) Appl. No.: 12/671,717

(22) PCT Filed: Jul. 28, 2008
(86) PCT No.: PCT/JP2008/063510

§ 371 Date: Feb. 2, 2010

(30) Foreign Application Priority Data
Sep. 4, 2007 (JP) 2007-229083

(51) Int. Cl. B41L 25/12

(52) U.S. Cl. 101/147

(57) ABSTRACT

There are provided damping water circulators (3a, 3b, 3c, and 3d) for circulating damping water among printing presses (2a, 2b, 2c, and 2d) to purify the damping water.

The damping water circulator includes upper and lower tanks(8, 9) and a purification unit (10) provided between the upper and lower tanks (8, 9). The damping water returning from the printing presses (2a, 2b, 2c, and 2d) is purified by the purification unit and stored in the lower tank 9. The damping water is then transferred from the lower tank 9 to the upper tank 8 and is supplied to the printing presses (2a, 2b, 2c, and 2d). Water supply for replenishment to the damping water is stopped at a predetermined time before ending of print operation of the printing presses (2a, 2b, 2c, and 2d) and the damping water remaining in the upper and lower tanks (8, 9) is consumed during the predetermined period of time.

### TECHNICAL FIELD

The present invention relates to a damping water circulator for circulating damping water among printing presses to purify the damping water in offset printing.

### BACKGROUND TECHNOLOGY

Generally, in offset printing, damping water is indispensable and a damping water circulator is provided which circulates the damping water among printing presses to purify it.

Conventionally, the damping water circulator of this kind is configured so that, after circulating damping water among printing presses and regenerating damping water returned from water vessels provided for every printing color into clean damping water, the clean damping water is again supplied to each water vessel (for example, see Patent Reference 1).

### Patent Reference 1: Japanese Patent Application Laid-open No. 2004-351745.

### DISCLOSURE OF THE INVENTION

### Problems to be Solved by the Invention

However, the conventional damping water circulator described above has a problem in that, since damping water in the water vessel for all printing colors is treated by one damping water circulator, a total amount of damping water becomes large which makes it impossible to be fully purified, thus causing a trouble in operations of the printing presses due to pollution and decay of the damping water.

Also, the continued circulation of the damping water causes the pollution and decay to progress to a degree to which the damping water becomes gradually unusable, which requires periodical replacement work of the damping water. As a result, problems arise that time and efforts are needed to perform the replacement work of the damping water and, since waste liquid from the damping water is treated as industrial waste when being replaced, it is necessary to entrust a specialized dealer with the waste liquid treatment, which increases costs for the treatment.

The present invention has been made in light of the problems described above and has an object to provide a damping water circulator capable of improving purification performance and eliminating the need for replacement work of damping water and waste water treatment.

### Means for Solving Problems

In order to achieve the above object, according to the present invention, there is provided a damping water circulator for circulating damping water among printing presses to purify the damping water, which includes upper and lower tanks, and a purification unit provided between the upper and lower tanks, wherein the damping water returned from the printing presses is purified by the purification unit and is stored in the lower tank and, after being transferred from the lower tank to the upper tank, is supplied to each of the printing presses and supply of replenishing water for the damping water is stopped at a predetermined time before ending of printing operations of each of the printing presses and the damping water remaining in the upper and lower tanks is consumed for a predetermined period of time.

The damping water circulator is preferably so configured that, when a water level in its upper tank falls below a lower limit value, the supply of replenishing water for the damping water is started and, when the water level in its upper tank exceeds an upper limit value, the supply of replenishing water for the damping water is stopped.

The damping water circulator is preferably so configured that overflow equipment is provided in its upper tank and damping water in its upper tank is supplied through the overflow equipment to its purification unit.

The damping water circulator is preferably so configured that, when a water level in its lower tank falls below a lower limit value, sending-out of damping water to its upper tank is stopped and, when a water level in its lower tank exceeds an upper limit value, the sending-out of damping water to its upper tank is started.

The damping water circulator is preferably configured so as to be provided for every printing press operating for each different color.

The damping water circulator is so configured that its purification unit is equipped with a detachable filter box and a folding-type cutwater pan, and a filter housed in the filter box is able to be replaced on the cutwater pan.

### Effects of the Invention

According to the present invention, purification performance of damping water can be improved and the need for the replacement of damping water and for the waste liquid treatment of damping water can be eliminated and maintenance work can be simplified and maintenance costs can be reduced.

### BRIEF DESCRIPTION OF DRAWINGS

FIG. 1 is a schematic diagram showing a damping water circulator with a damping water circulating system according to an embodiment of the present invention.

FIG. 2 is a perspective view of the damping water circulator of the embodiment of the present invention.

FIG. 3 is a perspective view of a purification unit of the damping water circulator of the embodiment of the present invention.

FIG. 4 is a perspective view showing a state in which a filter of the purification unit of the damping water circulator of the embodiment of the present invention is replaced.

### BEST MODE CARRYING OUT THE INVENTION

Hereinafter, an embodiment of the present invention is described by referring to drawings.

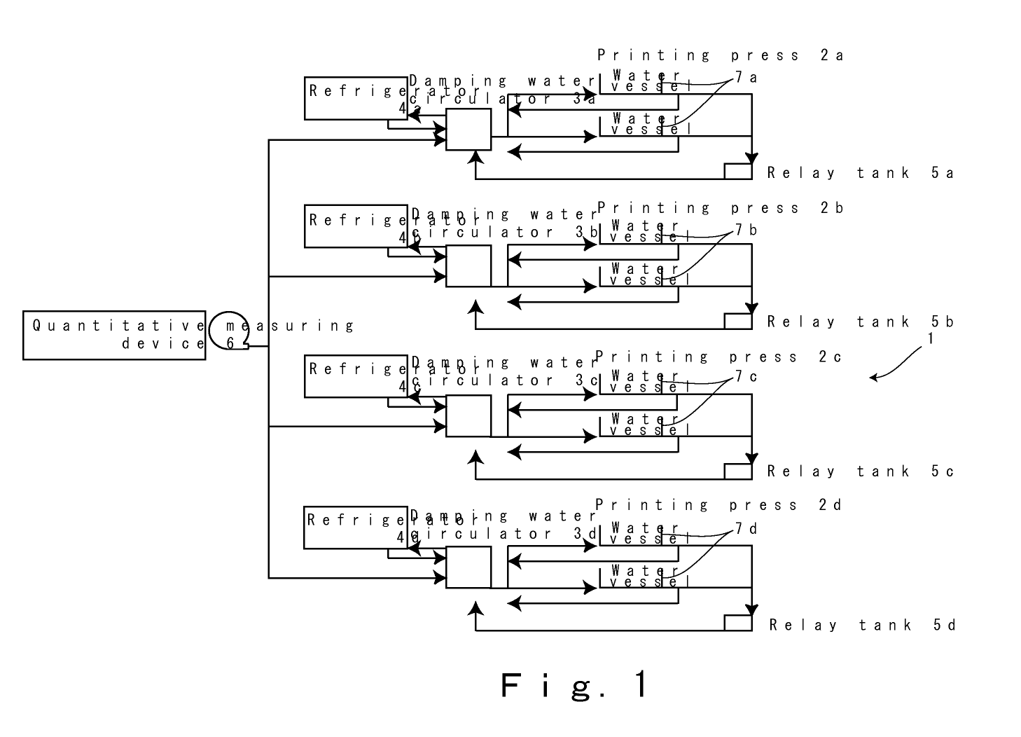

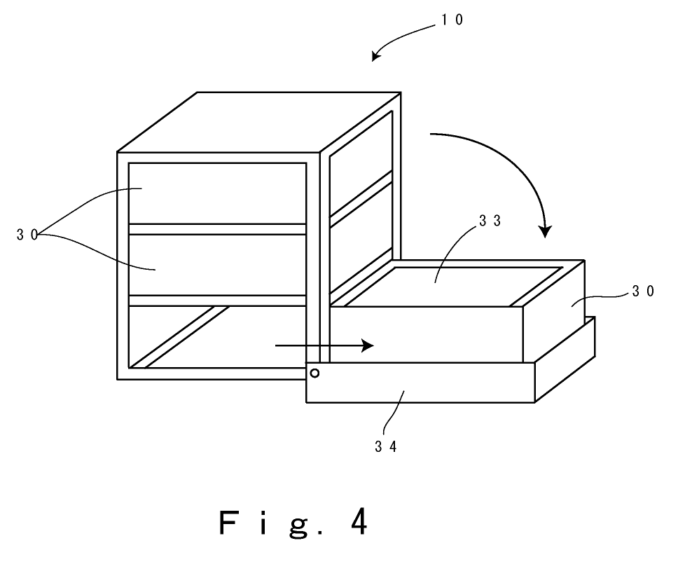

FIG. 1 is a schematic diagram showing a damping water circulator with a damping water circulating system of the embodiment of the present invention. The damping water circulating system 1 includes printing presses 2a, 2b, 2c, and 2d each being provided for each of a plurality of printing colors (for example, four colors in FIG. 4), damping water circulators 3a, 3b, 3c, and 3d of the embodiment of the present invention, refrigerators 4a, 4b, 4c, and 4d, relay tanks 5a, 5b, 5c, and 5d, and one unit of a quantitative measuring device 6. Each of the printing presses 2a, 2b, 2c, and 2d has two units of water vessels 7a, 7b, 7c, and 7d.

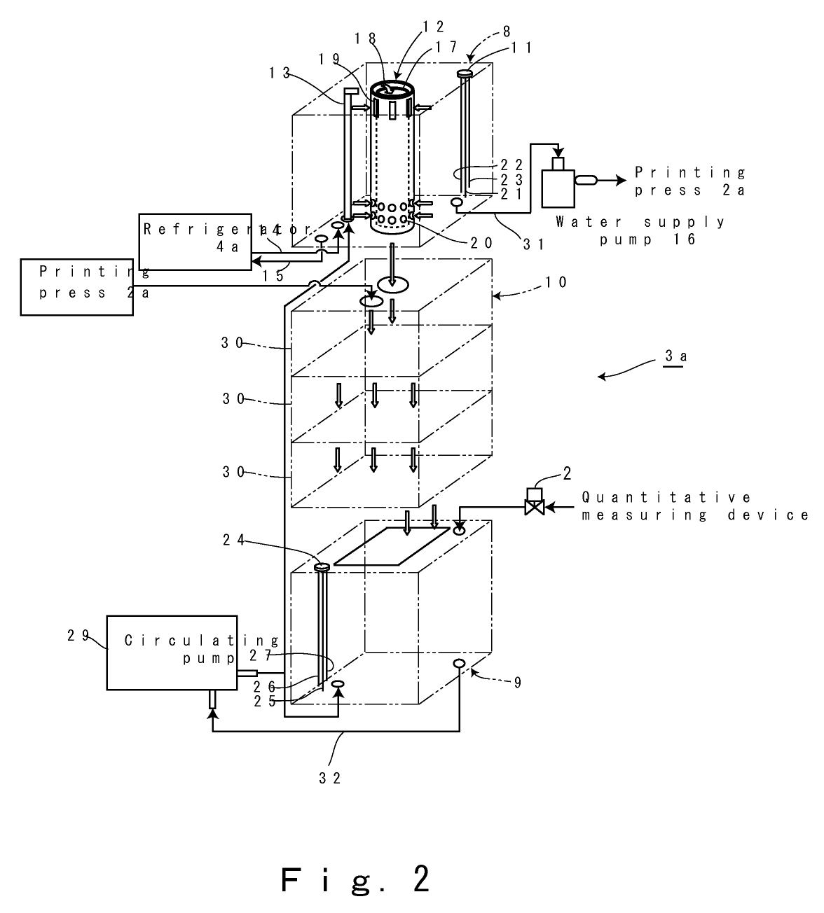

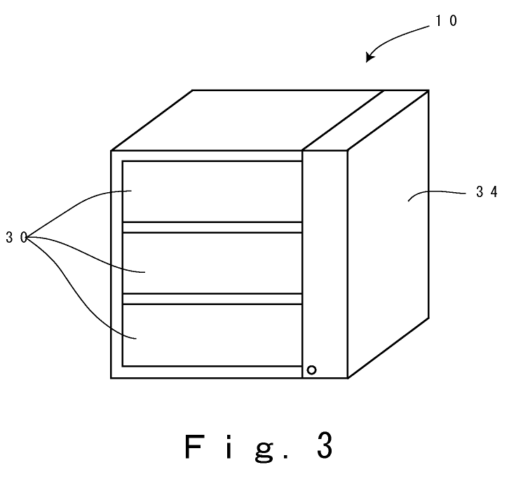

Next, by referring to FIGS. 2 to 4, configurations of the damping water circulators 3a, 3b, 3c, and 3d of the embodiment of the present invention are explained. FIG. 2 is a perspective view of one of the damping water circulators 3a, 3b, 3c, and 3d of the embodiment of the present invention. FIG. 3 is a perspective view of a purification unit making up the damping water circulators 3a, 3b, 3c, and 3d of the embodiment of the present invention. FIG. 4 is a perspective view showing a state in which the filter of the purification unit of the damping water circulators 3a, 3b, 3c, and 3d of the embodiment of the present invention is replaced. All the damping water circulators 3a, 3b, 3c, and 3d have the same configurations and, therefore, a configuration of the damping water circulator 3a is described as a typifying example.

The damping water circulator 3a of the embodiment of the present invention is provided with upper and lower tanks 8 and 9, and the purification unit 10 interposed between the upper and lower tanks 8 and 9.

The upper tank 8 has a water level sensor 11 to detect a water level in the upper tank 8, overflow equipment 12 to supply damping water stored in the upper tank 8 to the purification unit 10, and supply equipment 13 to supply damping water from the lower tank 9 to the upper tank 8. To a lower face of the upper tank 8 is connected the refrigerator 4a via a supply tube 14 and returning tube 15 and each of the supply tube 14 and returning tube 15 has a double tap valve (not shown) interposed between the refrigerator 4a and upper tank 8, which enables simplification of detachment of the refrigerator 4a from the upper tank 8. Also, to a lower face of the upper tank 8 is connected a water supply pump 16 via a supply tube 31 and on the upstream side and on the downstream of the water supply pump 16 are connected double tap valves (not shown) each interposed between the water supply pump 16 and the upper tank 8, which enables simplification of replacement work of the water supply pump 16.

The overflow equipment 12 is double-structured by an inner cylinder 17 and outer cylinder 18 both having a cylindrical shape, in which the inner cylinder 17 is slightly lower than the outer cylinder 18 and a plurality of through holes 19 and 20 is formed in the upper and lower portions of the outer cylinder 18. By configuring as above, as shown by arrows in FIG. 2, damping water in the upper tank 8 flows in between the outer cylinder 18 and inner cylinder 17 via the through holes 19 and 20 and then flows over an upper end of the inner cylinder 17 and flows into the inner cylinder 17. The water level sensor 11 has three electrode bars (first to third electrode bars 21, 22, and 23) having a length different from one another.

The lower tank 9 is provided with a water level sensor 24 to detect a water level in the lower tank 9 and the water level sensor 24 has three electrode bars (first to third electrode bars 25, 26, and 27). The quantitative measuring device 6 is connected through an electromagnetic valve 28 to the lower tank 9 and on the upstream side and on the downstream of the electromagnetic valves 28 are connected double tap valves (not shown) each interposed between the electromagnetic valves 28 and the lower tank 9, which enables the simplification of replacement work of the electromagnetic valves 28. Moreover, a circulating pump 29 is connected through a circulating pipe 32 to a lower face of the lower tank 9 and on the upstream side and on the downstream of the circulating pump 29 are connected double tap valves (not shown) each interposed between the circulating pump 29 and the lower tank 9, which enables the simplification of replacement work of the circulating pump 29.

As shown well in FIGS. 3 and 4, the purification unit 10 has plural-stage filter boxes 30 (for example, three-stage filter boxes shown in FIGS. 2 and 3) formed so as to be able to slide horizontally and to be detachable and a filter 33 is housed in each of the filter boxes 30. The purification unit 10 has a folding-type cutwater pan 34 formed in a manner to pivot on a corner portion at its lower end. At a time of replacement of the filter 33, by rotating the cutwater pan 34 and by sliding each of the filter boxes 30 on the cutwater pan 34, water dripped from the filter 33 is received by the cutwater pan 34 and is allowed to drop into the lower tank 9, thereby preventing a floor from getting wet and from being stained, which enables smooth replacement of the filter 33.

Next, actions of the damping water circulator 3a of the present invention are described by referring to FIGS. 1 and 2. Moreover, the actions of all the damping water circulators 3a, 3b, 3c, and 3d are the same and, therefore, the action of the damping water circulator 3a is described as a typifying example.

The damping water being stored in the upper tank 8 above the damping water circulator 3a is transferred by the water supply pump 16 to the printing press 2a and then is distributed to the water vessels 7a. In the printing press 2a, water is supplied from a roller (not shown) being in contact with a water surface of the water vessel 7a to a printing plate, where printing operations are performed and the damping water not consumed in the printing press 2a is gathered in the relay tank 5a and then is returned to the purification unit 10 of the damping water circulator 3a.

In the purification unit 10, paper powder and/or other powder, or the like contained in the damping water during the printing operations of the printing press 2a are removed and purified by the filter 33 in the filter box 30 and the purified damping water is stored in the lower tank 9.

A water level in the lower tank 9 is monitored by the water level sensor 24 and, when the water level in the lower tank 9 exceeds its lower end level (upper limit value) of the third electrode bar 27, the circulating pump 29 is driven to start the sending-out of damping water from the lower tank 9 to the upper tank 8. On the other hand, when the water level in the lower tank 9 falls below its lower end level (lower limit value) of the second electrode bar 26, operations of the circulating pump 29 are stopped and sending-out of damping water from the lower tank 9 to the upper tank 8 is stopped.

The damping water sent out from the lower tank 9 by the circulating pump 29 is supplied through the supply equipment into the upper tank 8 and is stored therein. The water level in the upper tank 8 is monitored by the water level sensor 11 and, when the water level in the upper tank 8 falls below its lowest end level (lower limit value) of the second electrode bar 22, the electromagnetic valve 28 is opened and damping water having a specified concentration of etching liquid is replenished from the quantitative measuring device 6 into the upper tank 8 and, as described above, the damping water is further supplied by the circulating pump 29 to the upper tank 8. On the other hand, when the water level in the upper tank 8 exceeds its lowest end level (upper limit value) of the third electrode bar 23, the electromagnetic valve 28 is closed and the replenishment of damping water from the quantitative measuring device 6 to the lower tank 8 is stopped.

The temperature of damping water in the upper tank 8 is ordinarily monitored by a liquid temperature indicator (not shown) and, in accordance with the result from the monitoring, the damping water is cooled by the refrigerator 4a down to a specified temperature so that temperatures of the damping water in the upper tank 8 are kept constant.

The damping water having a specified concentration of etching liquid and a specified temperature supplied to the upper tank 8 is then transferred to the printing press 2a and circulates between the upper tank 8 and the printing press 2a and a predetermined printing operation is performed in the printing press 2a.

Even if suspended substances such as paper powder or other powder are contained in the damping water in the upper tank 8, the damping water flows via the through holes 19 and 20 between the outer cylinder 18 and the inner cylinder 19 and then flows over an upper end of the inner cylinder 17, together with suspended substances such as paper powder or other powder floating in an upper portion of the damping water, into the inner cylinder 17 and is supplied to the purification unit 10 for being purified, which enables clean damping water to be surely and ordinarily supplied to the printing press 2a.

As described above, the damping water is circulated between the damping water circulator 3a and printing press 2a for being purified and, in the printing operations performed by the printing press 2a, when an instruction for stopping the printing press 2a is provided from an unillustrated control board to the printing press 2a at a predetermined time before ending of printing operations, manually by an operator or automatically by an operation of a preset timer (not shown), the electromagnetic valve 28 is closed, and replenishment of the damping water to the lower tank 8 from the quantitative measuring device 6 is stopped.

Thereafter, the damping water remaining in the lower tank 9 is supplied to the upper tank 8 by driving of the circulating pump 29 described above and the remaining damping water from the upper tank 8 is fed for the predetermined period of time before ending of specified printing operations by the printing press 2a and is consumed therein.

Thus, described as above, according to the damping water circulators 3a, 3b, 3c, and 3d of the embodiment, the electromagnetic valve 28 is closed at a predetermined time before the ending of operations of the printing press 2a and the replenishment of the damping water is stopped and the damping water remaining in the upper and lower tanks 8 and 9 is consumed during printing operations within the predetermined time period, periodic replacing operation of the damping water is not needed and wastewater treatment is not required. As a result, the maintenance work can be simplified and maintenance costs can be reduced.

Moreover, the damping water overflown from the upper tank 8 flows into the purification unit 10, which enables higher purification efficiency of the damping water and improved purification performance.

Each of the damping water circulators 3a, 3b, 3c, and 3d is provided for each of the printing presses 2a, 2b, 2c, and 2d operating for each different color and, therefore, an amount of the damping water to be treated by each of the damping water circulators 3a, 3b, 3c, and 3d becomes small and retention time of the damping water is shortened, which enables the improved stability of etching concentration and pH of the damping water. By providing each of the damping water circulators 3a, 3b, 3c, and 3d, adverse effects such as excessive emulsification caused by other colors can be prevented. Each of the refrigerators 4a, 4b, 4c, and 4d is provided for each of the damping water circulators 3a, 3b, 3c, and 3d, thus enabling the temperature setting of water to be changed for each of the printing presses 2a, 2b, 2c, and 2d and improved printing accuracy. Moreover, the damping water circulator 3a, 3b, 3c, and 3d of the printing presses 2a, 2b, 2c, and 2d being not in use can be powered off, thereby enabling economic operations of the damping water circulating system and the selection of kinds of etching liquid for each of the printing presses 2a, 2b, 2c, and 2d.

Additionally, in the embodiment described above, the damping water circulators 3a, 3b, 3c, and 3d are provided for each of the printing presses 2a, 2b, 2c, and 2d operating for each color, however, this is simply an example and, for example, one damping water circulator may be provided for the two printing presses each operating for each different color, thus the number of units of the damping water circulators can be changed in a variety of ways.

In the above embodiment, only one quantitative measuring device 6 is installed, however, the quantitative measuring device may be installed for each of the damping water circulators 3a, 3b, 3c, and 3d. Moreover, IPA (isopropyl alcohol), besides the etching liquid, may be added to the damping water to be replenished from the quantitative measuring device 6.

1. A damping water circulator for circulating damping water among printing presses to purify the damping water comprising:
upper and lower tanks; and
a purification unit provided between said upper and lower tanks;
wherein the damping water returned back from said printing presses is purified by said purification unit and is stored in the lower tank and, after being transferred from the lower tank to the upper tank, is supplied to each of said printing presses and supply of replenishing water for the damping water is stopped at a predetermined time before ending of printing operations of each of said printing presses and the damping water remaining in said upper and lower tanks is consumed for a predetermined period of time.

2. The damping water circulator according to claim 1, wherein, a water level in said upper tank falls below a lower limit value, the supply of replenishing water for the damping water is started and, when the water level in said upper tank exceeds an upper limit value, the supply of replenishing water for the damping water is stopped.

3. The damping water circulator according to claim 1, wherein overflow equipment is provided in said upper tank and damping water in said upper tank is supplied through said overflow equipment to said purification unit.

4. The damping water circulator according to claim 1, wherein, when a water level in said lower tank falls below a lower limit value, sending-out of damping water to said upper tank is stopped and, when a water level in said lower tank exceeds an upper limit value, the sending-out of damping water to said upper tank is started.

5. The damping water circulator according to claim 1, wherein said damping water circulator is provided for every printing press operating for each different color.

6. The damping water circulator according to claim 1, wherein said purification unit is equipped with a detachable filter box and a folding-type cutwater pan and a filter housed in the filter box is able to be replaced on the cutwater pan.
